(19) United States
(12) Patent Application Publication
(10) Pub. No.: US 2022/0198561 A1
(43) Pub. Date: Jun. 23, 2022

(54) INFORMATION PROCESSING APPARATUS, INFORMATION PROCESSING METHOD, AND PROGRAM

(71) Applicant: Nomura Research Institute, Ltd., Tokyo (JP)

(72) Inventor: Fumiya MUTO, Tokyo (JP)

(21) Appl. No.: 17/474,275

(22) Filed: Sep. 14, 2021

(30) Foreign Application Priority Data
Dec. 18, 2020 (JP) 2020-210366

(51) Int. Cl. G06Q 40/04; G06Q 30/02

(52) U.S. Cl. CPC G06Q 40/04; G06Q 30/0277

(57) ABSTRACT

Problems to be solved

An information processing apparatus, an information processing method, and a program that can enhance an advertising effect are provided.

Solution

An information processing apparatus according to an aspect of the present invention includes: an advertisement request acquisition unit configured to acquire, from a financial service providing system for providing a service related to financing, user identification information for identifying a user of the service and a request for provision of an advertisement to be displayed in association with the service; a brand identification information acquisition unit configured to refer to a predetermined storage unit to acquire brand identification information for identifying a brand associated with a financial instrument associated with the user, the brand identification information being associated with the user identification information; a content data acquisition unit configured to acquire, from a content server configured to manage content data in association with content provider identification information for identifying a provider of contents, content data associated with the content provider identification information corresponding to the brand identification information that is identified; an advertisement data generation unit configured to generate advertisement data including the acquired content data; and an advertisement data transmission unit configured to transmit the generated advertisement data to the financial service providing system.

### TECHNICAL FIELD

The present invention relates to an information processing apparatus, an information processing method, and a program.

### BACKGROUND ART

An advertisement distribution system that distributes online advertisements to customers via a website has hitherto been widely used. In distribution of online advertisements, various techniques for achieving a high advertising effect have been proposed. For example, PTL 1 discloses an information processing system that statistically processes a customer associated database including characteristics data of customers, generates a plurality of processed databases including characteristics data for each virtual customer corresponding to a plurality of customers having similar characteristics, and combines those.

### CITATION LIST

### Patent Literature

PTL 1: JP 2016-38780 A

### SUMMARY OF INVENTION

### Technical Problem

In recent years, in response to growing concern with asset building, websites and applications for purchase and management of financial instruments such as stocks and investment trusts have been sophisticated, and investment has become widely spread even among general consumers. It is assumed that one useful means for enhancing performance of asset management is to examine and deepen understanding of a brand company being an investment target, and investors often have great concern with a brand company that has influence on their asset management. Thus, investors are likely to be good potential customers for the brand company, and great enhancement of the advertising effect is expected by appropriately placing advertisements associated with the financial instruments for the investors.

In view of this, the present invention has an object to provide an information processing apparatus, an information processing method, and a program that can enhance an advertising effect.

### Solution to Problem

An information processing apparatus according to an aspect of the present invention includes: an advertisement request acquisition unit configured to acquire, from a financial service providing system for providing a service related to financing, user identification information for identifying a user of the service and a request for provision of an advertisement to be displayed in association with the service; a brand identification information acquisition unit configured to refer to a predetermined storage unit to acquire brand identification information for identifying a brand associated with a financial instrument associated with the user, the brand identification information being associated with the user identification information; a content data acquisition unit configured to acquire, from a content server configured to manage content data in association with content provider identification information for identifying a provider of contents, content data associated with the content provider identification information corresponding to the brand identification information that is identified; an advertisement data generation unit configured to generate advertisement data including the acquired content data; and an advertisement data transmission unit configured to transmit the generated advertisement data to the financial service providing system.

According to the aspect, in the financial service providing system for providing a service related to financing, a displayed advertisement includes content data related to a content provider corresponding to a brand associated with a financial instrument associated with a user. Therefore, the advertising effect is enhanced.

### Advantageous Effects of Invention

According to the present invention, an information processing apparatus, an information processing method, and a program that can enhance an advertising effect can be provided.

### BRIEF DESCRIPTION OF DRAWINGS

FIG. 1 is a diagram for illustrating an overview of an advertisement system 1.

FIG. 2 is a schematic diagram illustrating an exemplary hardware configuration of a computer 500.

FIG. 3 is an exemplary block diagram illustrating a functional configuration of a medium server 110.

FIG. 4 is an exemplary block diagram illustrating a functional configuration of a user terminal 120.

FIG. 5 is an exemplary block diagram illustrating a functional configuration of a matching server 200.

FIG. 6 is a diagram illustrating an exemplary data structure of a user information DB 210A.

FIG. 7 is a diagram illustrating an exemplary data structure of a fund constituent brand DB 210B.

FIG. 8 is an exemplary block diagram illustrating a functional configuration of a content server 300.

FIG. 9 is a diagram illustrating an exemplary data structure of a content data DB 310.

FIG. 10 is a diagram illustrating an exemplary operation sequence related to processing executed by the advertisement system 1.

FIG. 11 is a diagram illustrating an exemplary display screen of an advertisement in a financial service.

FIG. 12 is a diagram illustrating an exemplary display screen of an advertisement shared in an SNS.

### DESCRIPTION OF EMBODIMENTS

A preferable embodiment of the present invention will be described with reference to the attached drawings. (Note that, in figures, an element that is denoted by the same reference sign has the same or similar configuration.)

### (1) Overall Configuration

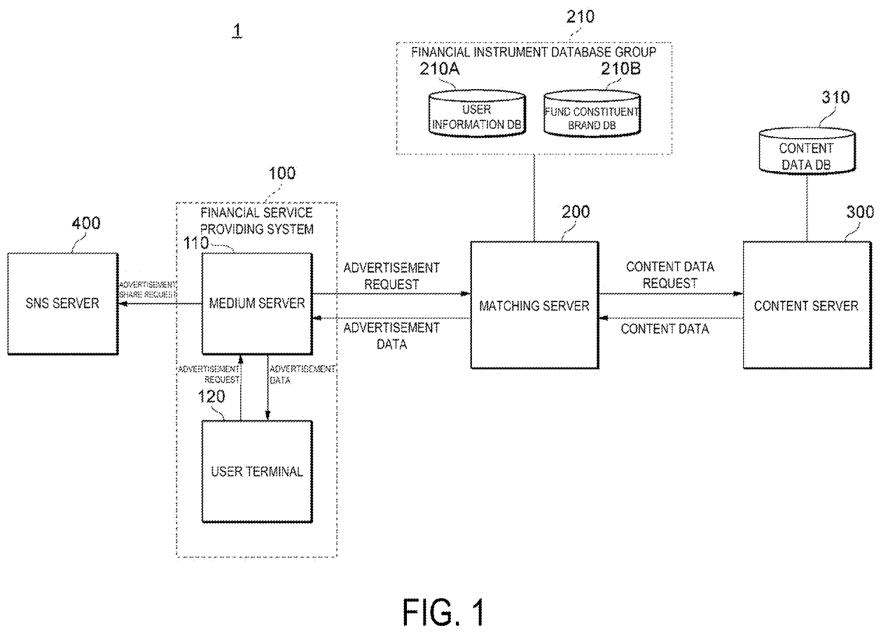

FIG. 1 is a schematic diagram illustrating an exemplary configuration of an advertisement system 1 according to an embodiment. As illustrated in FIG. 1, the advertisement system 1 includes, for example, a financial service providing system 100, a matching server 200, a content server 300, and an SNS server 400 that are communicably connected with each other via a predetermined communication network.

The financial service providing system 100 is a system for providing predetermined financial services for a user, and includes, for example, a medium server 110 that provides financial services and a user terminal 120 used by the user. Here, details of the financial services provided by the financial service providing system 100 are not specifically limited as long as the financial services are services related to financing (not only financing as a business but also financing as used in a broad sense including raising, using, and the like of funds), and may include, for example, financial services related to financial instruments such as stocks, investment trusts, bonds, government bonds, and money orders, and financial services related to payments using legal tender, electronic money, and crypto-assets (including virtual currency). The form of provision of financial services in the financial service providing system 100 is not specifically limited, for example, the form may be a form (so-called, a website, a service website, an application, or the like) in which display data supplied from the medium server 110 and/or display data stored in the user terminal 120 is displayed in the user terminal 120 via a browser or an application (a Web application and/or a client application) installed in the user terminal 120. Examples of financial services specifically assumed as the financial services provided by the financial service providing system 100 include, but are not limited to, a website (HP) and an application of a company that directly sells investment trusts, an HP and an application of a company that sells financial instruments (a bank, a securities broker, an insurance company, or the like), an application and Web services of household account book services, a settlement (payment) application, investment trust information services, and the like. The financial services provided by the financial service providing system 100 may include financial services (face-to-face and/or non-face-to-face) provided as a shared service between an administrator of the medium server 110 and an administrator of the matching server 200 which will be described below. Note that, in FIG. 1, only one user terminal 120 is illustrated. However, the financial service providing system 100 may include a plurality of user terminals 120.

In the financial service providing system 100, a screen for financial services displayed in the user terminal 120 or the like may display, for example, an advertisement related to brands associated with financial instruments (stocks, stock funds, funds of funds, exchange traded funds (ETFs), fund wraps/discretionary investment contracts, robo-advisors, financial instruments adopted for the index of increase and decrease of points in a point management service, or the like) associated with the user provided by the matching server 200. Here, the “financial instruments associated with the user” may broadly include financial instruments associated with the user in any form, and may specifically include financial instruments held by the user, financial instruments associated by the user (bookmark registration, registration of funds of interest, or the like), financial instruments associated by a provider of the financial services (registration or the like of recommendation by a company that sells financial instruments (a bank, a securities broker, or the like)), and the like. In a loyalty program in which points are provided through use or the like of goods and services of specific companies, a service of so-called “point management” has been used so that the points increase and decrease in conjunction with a predetermined index. In the “point management”, a predetermined financial instrument (a fund, an ETF, or the like) may be used as such a predetermined index for causing conjunction with increase and decrease of points. The above-described financial instruments associated with the user may include a financial instrument used as a predetermined index for causing conjunction with increase and decrease of points in “point management” as described above. The “brands associated with the financial instruments associated with the user” may be, for example, a brand itself (first brand) included in the financial instrument, or may be a brand (second brand) associated with the brand (first brand). The relationship between the first brand and the second brand may be a capital relationship, a business relationship, and any other relationship. Specifically, for example, the second brand may be a brand (a subsidiary company of the first brand or the like) having a capital relationship with the first brand, or the second brand may be a brand (a customer company of the first brand or the like) having a business relationship with the first brand.

First, for example, when the user performs predetermined operation or the like, the medium server 110 transmits, to the matching server 200, an advertisement request which is a request for provision of an advertisement to be displayed in association with the financial service. Next, the matching server 200 appropriately acquires information from a financial instrument database group 210 in which the financial instrument associated with the user (the financial instrument held by the user, the financial instrument associated with the user) and the brand included in the financial instrument (the first brand included in the financial instrument, the second brand having a predetermined relationship with the first brand, or the like) are stored in direct or indirect association with a user ID, and then identifies a brand associated with the financial instrument associated with the user. Next, the matching server 200 acquires content data associated with the identified brand from the content server 300 that manages a content data DB 310 storing content data available for the advertisement. Next, the matching server 200 generates advertisement data based on the acquired content data, and transmits the generated advertisement data to the medium server 110. Then, the user terminal 120 acquires the advertisement data from the medium server 110, and displays the advertisement related to the brand associated with the financial instrument associated with the user on the screen of the financial service or the like, based on the advertisement data.

In this manner, in the advertisement system 1 according to the present embodiment, the advertisement of the brand associated with the financial instrument associated with the user can be displayed in the financial service in the financial service providing system 100. It can be said that the user who, for example, holds the financial instrument is often highly sensitive to a company of the brand associated with the financial instrument or the like, and thus an advertising effect is enhanced owing to the advertisement system 1 according to the present embodiment.

In the advertisement system 1 according to the present embodiment, the user can share the advertisement displayed in the user terminal 120 with any social networking service (SNS). A hashtag or the like including display related to the financial instrument, such as “#invested by xx” (where xx is a fund name), may be added to the advertisement shared with the SNS. In this manner, display related to the financial instrument including a provider of contents related to the advertisement, a company associated with the provider, or the like as a brand is added to the advertisement shared with the SNS, and thus the degree of recognition of the financial instrument from other users who come across the display can be enhanced. Then, users of the financial service provided by the medium server 110 and users associated with the recognized financial instrument are increased. As a result, targets of the display of the advertisement can further be increased. Owing to these effects, an effect of widely popularizing investment among general consumers can be expected.

### (2) Configuration of Each Unit

### (2-1) Hardware Configuration

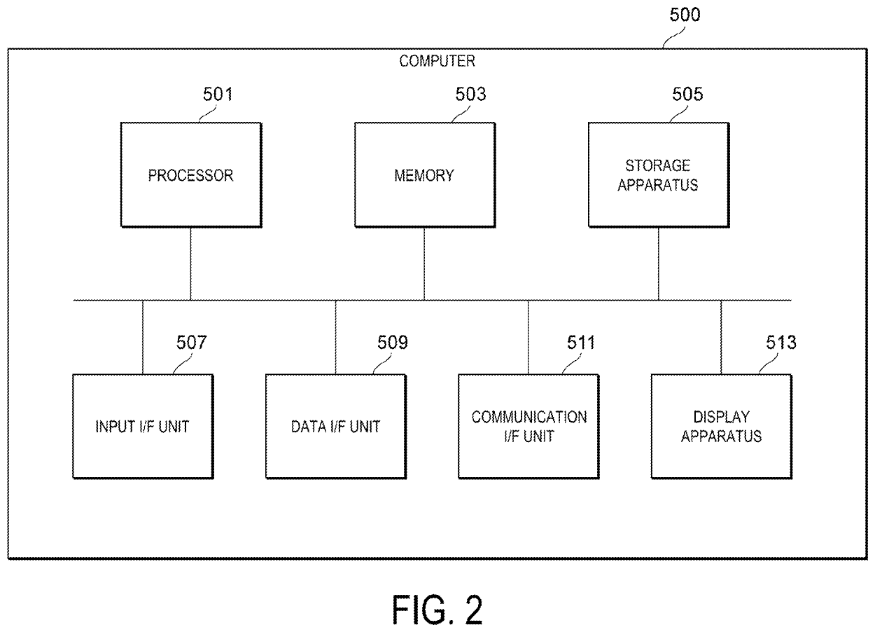

A hardware configuration of each of the medium server 110, the user terminal 120, the matching server 200, the content server 300, and the SNS server 400 will be described. Each of these can include one or a plurality of computers 500. FIG. 2 is a schematic diagram illustrating an exemplary hardware configuration of the computer 500.

As illustrated in FIG. 2, the computer 500 includes a processor 501, a memory 503, a storage apparatus 505, an input I/F unit 507, a data I/F unit 509, a communication I/F unit 511, and a display apparatus 513.

The processor 501 executes a program stored in the memory 503 and thereby controls various types of processing in the computer 500. For example, an advertisement request transmission unit 111, an advertisement data acquisition unit 112, an advertisement data transmission unit 113, and an advertisement share request transmission unit 114 included in the medium server 110, an operation reception unit 121, an advertisement request transmission unit 122, an advertisement data acquisition unit 123, an output unit 124, and an advertisement share request transmission unit 125 included in the user terminal 120, an advertisement request acquisition unit 201, a customer attribute information acquisition unit 202, a fund ID acquisition unit 203, a constituent brand ID acquisition unit 204, an advertisement data generation unit 206 and an advertisement data transmission unit 207 included in the matching server 200, and the like are temporarily stored in the memory 503, and can then be implemented as programs operating mainly in the processor 501.

The memory 503 is, for example, a storage medium such as a random access memory (RAM). The memory 503 temporarily stores a program code of a program executed by the processor 501 and data necessary at the time of execution of the program.

The storage apparatus 505 is, for example, a non-volatile storage medium such as a hard disk drive (HDD) and a flash memory. The storage apparatus 505 stores an operating system, and various programs for implementing the configurations described above. Such programs and pieces of data are loaded into the memory 503 as necessary, and are thereby referred to by the processor 501.

The input I/F unit 507 is a device for receiving input from an administrator. Specific examples of the input I/F unit 507 include a keyboard, a mouse, a touch panel, various sensors, and a wearable device. The input I/F unit 507 may be, for example, connected to the computer 500 via an interface such as a universal serial bus (USB).

The data I/F unit 509 is a device for inputting data from the outside of the computer 500. Specific examples of the data I/F unit 509 include a drive apparatus for reading data stored in various storage mediums. The data I/F unit 509 may be provided outside of the computer 500. In that case, the data I/F unit 509 is, for example, connected to the computer 500 via an interface such as a USB.

The communication I/F unit 511 is a device for performing data communication via the Internet using wired or wireless connection with an apparatus outside of the computer 500. The communication I/F unit 511 may be provided outside of the computer 500. In that case, the communication I/F unit 511 is, for example, connected to the computer 500 via an interface such as a USB.

The display apparatus 513 is a device for displaying various pieces of information. Specific examples of the display apparatus 513 include a liquid crystal display, an organic electro-luminescence (EL) display, and a display of a wearable device. The display apparatus 513 may be provided outside of the computer 500. In that case, the display apparatus 513 is, for example, connected to the computer 500 via a display cable or the like.

### (2-2) Functional Configurations of Medium Server 110

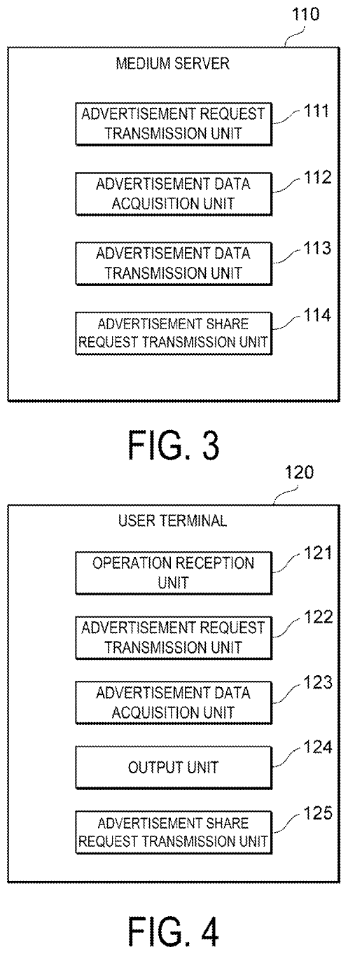

FIG. 3 is an exemplary block diagram illustrating a functional configuration of the medium server 110. The medium server 110 includes one or a plurality of computers 500, and processes various pieces of data related to the financial service in response to a request from the user terminal 120. The medium server 110 includes, for example, an advertisement request transmission unit 111, an advertisement data acquisition unit 112, an advertisement data transmission unit 113, and an advertisement share request transmission unit 114.

For example, when the advertisement request transmission unit 111 receives an advertisement request (request for provision of an advertisement to be displayed in association with the financial service) from the user terminal 120 or the like, the advertisement request transmission unit 111 transmits a predetermined advertisement request to the matching server 200. The advertisement request transmission unit 111 may include, in the advertisement request, a user ID associated with the user terminal 120 and a media company ID associated with the medium server 110. The advertisement request transmission unit 111 may include information related to a display region of the advertisement (information related to the position, the size, and the like). The advertisement data acquisition unit 112 acquires, for example, advertisement data from the matching server 200. The advertisement data transmission unit 113 transmits, for example, the advertisement data to the user terminal 120. The advertisement share request transmission unit 114 requests the SNS server 400 to share a predetermined advertisement.

### (2-3) Functional Configuration of User Terminal 120

FIG. 4 is an exemplary block diagram illustrating a functional configuration of the user terminal 120. The user terminal 120 includes, for example, one or a plurality of computers 500. The user terminal 120 is, for example, an information processing apparatus such as a personal computer (PC), a mobile phone (a smartphone, a feature phone, or the like), and a tablet terminal. The user terminal 120 includes, for example, an operation reception unit 121, an advertisement request transmission unit 122, an advertisement data acquisition unit 123, an output unit 124, and an advertisement share request transmission unit 125.

The operation reception unit 121 receives, for example, any operation on the input I/F unit 507 performed by the user. The advertisement request transmission unit 122 transmits, to the medium server 110, for example, an advertisement request which is a request for provision of an advertisement to be displayed in the financial service in response to operation (advertisement display operation) or the like by the user. The advertisement data acquisition unit 123 acquires, for example, advertisement data from the medium server 110. The output unit 124 controls, for example, the display apparatus 513, and outputs an advertisement based on the advertisement data. The advertisement share request transmission unit 125 transmits, for example, a request for sharing of the advertisement to the SNS server 400 either via the medium server 110 or directly in response to operation (advertisement share operation) or the like by the user.

### (2-4) Functional Configuration of Matching Server 200

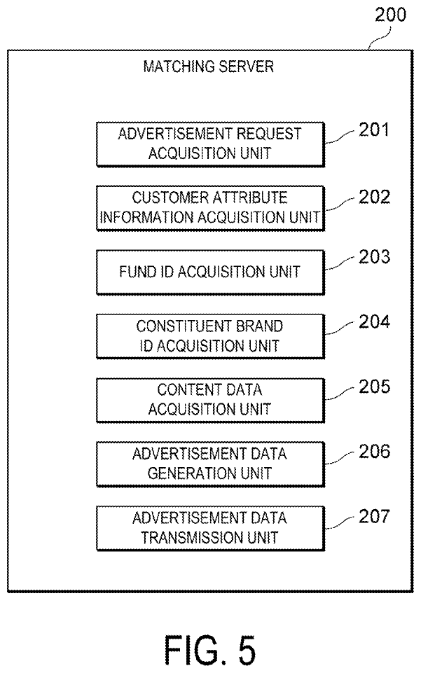

FIG. 5 is an exemplary block diagram illustrating a functional configuration of the matching server 200. The matching server 200 includes, for example, one or a plurality of computers 500, acquires predetermined content data from the content server 300 in response to the advertisement request acquired from the medium server 110, generates advertisement data based on the predetermined content data, and transmits the advertisement data to the medium server 110. The matching server 200 may have, for example, a function as a supply-side platform (SSP). The matching server 200 includes, for example, an advertisement request acquisition unit 201, a customer attribute information acquisition unit 202, a fund ID acquisition unit 203, a constituent brand ID acquisition unit 204, a content data acquisition unit 205, an advertisement data generation unit 206, and an advertisement data transmission unit 207.

The advertisement request acquisition unit 201 acquires, for example, the advertisement request from the medium server 110. The advertisement request may include, for example, a user ID and a media company ID. The customer attribute information acquisition unit 202 acquires, for example, customer attribute information (gender, age-group, residence, a work address, or the like) associated with the user ID in a user information DB 210A or the like.

The fund ID acquisition unit 203 and the constituent brand ID acquisition unit 204 constitute, for example, a “brand identification information acquisition unit”. Here, the “brand identification information acquisition unit” has a function of referring to a predetermined storage unit such as the financial instrument database group 210 to acquire brand identification information for identifying a brand associated with the financial instrument associated with the user, which is directly or indirectly associated with the user ID. The fund ID acquisition unit 203 acquires, for example, a fund ID associated with the user ID and the media company ID in the user information DB 210A. When there are a plurality of fund IDs associated with the user ID and the media company ID, the fund ID to be acquired may be determined based on a predetermined condition. For example, the fund ID to be acquired may be determined based on a fund balance, and in particular, a fund ID having the highest fund balance may be determined to be the fund ID to be acquired. Note that the fund ID acquisition unit 203 may acquire the fund ID associated with the user ID from another information processing apparatus (the medium server 110, the user terminal 120, or the like). The constituent brand ID acquisition unit 204 acquires, for example, a constituent brand ID associated with the fund ID (first brand ID which is an ID for identifying the first brand) in the fund constituent brand DB 210B. When there are a plurality of constituent brand IDs associated with the fund ID, the constituent brand ID to be acquired may be determined based on a predetermined condition. For example, it may be based on the proportion of constituent brands, and the constituent brand ID of the highest proportion among the constituent brand IDs having the same fund ID may be determined to be the one constituent brand ID described above. Note that the “brand identification information acquisition unit” may further include a second brand ID acquisition unit. The second brand ID acquisition unit acquires, for example, a second brand ID which is an ID for identifying the second brand associated with the first brand ID (brand associated with the first brand), based on the first brand ID (constituent brand ID). The second brand ID acquisition unit refers to a predetermined storage unit that stores the first brand ID and the second brand ID in association with each other, and can thereby acquire the second brand ID, based on the first brand ID. Here, the predetermined storage unit that stores the first brand ID and the second brand ID in association with each other may be included in the financial instrument database group 210, or may be configured as a part of the matching server 200. The predetermined storage unit can be freely configured depending on a type of relationship between the first brand and the second brand. For example, the predetermined storage unit may be a storage unit that defines a capital relationship between the first brand and the second brand, such as a stockholder database, or may be a storage unit that defines a business relationship between the first brand and the second brand, such as an (important) customer database.

The content data acquisition unit 205 transmits a predetermined content data request to the content server 300 in response to the advertisement request acquired from the medium server 110 or the like, and then acquires predetermined content data from the content server 300. In this process, the content data acquisition unit 205 may include, in the content data request to be transmitted to the content server 300, a content posting condition of the media company related to the medium server 110 (any condition related to the advertisement, such as the position, the size, a posting period, and the like of the advertisement), so as to request content data that matches the content posting condition. The content posting condition of the media company may be, for example, stored in the storage apparatus 505 of the matching server 200.

The matching server 200 can access the financial instrument database group 210. As illustrated in FIG. 1, the financial instrument database group 210 includes, for example, a user information DB 210A and a fund constituent brand DB 210B. Note that the financial instrument database group 210 may include a database that stores the above-described first brand and second brand in association with each other, in addition to the user information DB 210A and the fund constituent brand DB 210B.

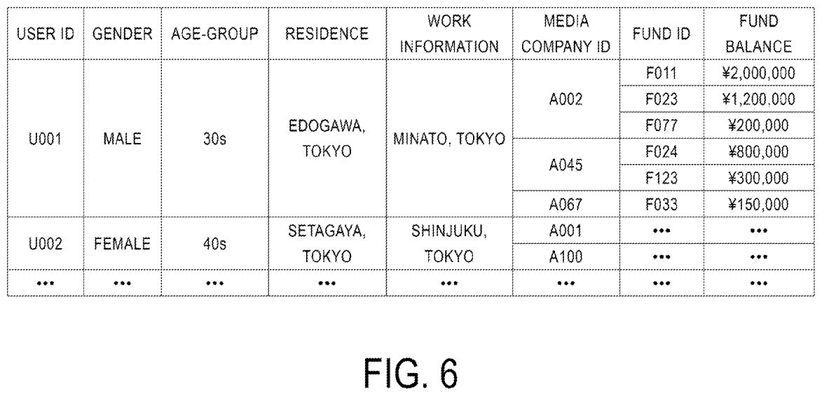

FIG. 6 is a diagram illustrating an exemplary data structure of the user information DB 210A. In the user information DB 210A, for example, “user information”, “gender”, “age-group”, “residence”, “work address”, “media company ID”, “fund ID”, “fund balance”, and the like are recorded in association with “user ID”. The user information DB 210A enables identification of a fund that a specific user holds, for example.

In “user ID”, for example, identification information (ID) for identifying a user is recorded. “Gender”, “age-group”, “residence”, and “work address” are examples of user attribute information which is attribute information of the user, and pieces of information indicating gender, age, residence, and a work address of the user are respectively recorded in these items. Note that the user attribute information is not limited to these items, and may include any other item.

In “media company ID”, for example, an ID for identifying an administrator of the medium server 110 (an example of “service provider identification information” for identifying a provider (media company) of the financial service) is recorded. In “fund ID”, for example, an ID for identifying a fund associated with the user (an example of “financial instrument identification information” for identifying a financial instrument, such as an investment trust, associated with the user) is recorded. Here, the fund associated with the user may broadly include a fund associated with the user in any form, and may specifically include a fund held by the user, a fund associated by the user (bookmark registration, registration of funds of interest, or the like), a fund associated by a provider of the financial service (registration of recommendation by a company that sells financial instruments (a bank, a securities broker, or the like) or the like), and the like. The fund associated with the user may include, for example, a fund adopted for the index of increase and decrease of points in a point management service. In “fund balance”, for example, the balance of the fund identified by the fund ID is recorded. Note that when a plurality of funds are managed in the financial services provided by the same media company, a plurality of “fund IDs” may be associated with one “media company ID”.

The information included in the user information DB 210A illustrated in FIG. 6 is an example, and the user information DB 210A need not include at least a part of the items described above, or may further include other items.

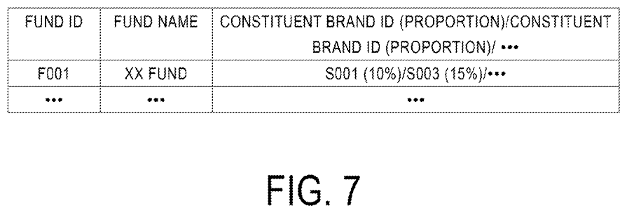

FIG. 7 is a diagram illustrating an exemplary data structure of the fund constituent brand DB 210B. In the fund constituent brand DB 210B, for example, “fund information”, “constituent brand ID”, and the like are recorded in association with “fund ID”. The fund constituent brand DB 210B enables identification of a brand included in the fund related to a specific fund ID.

In “fund ID”, for example, any fund ID is recorded. In “fund information”, for example, any piece of information (a name, attribute information, a sales company, or the like) related to the fund identified by the fund ID is recorded. In “constituent brand ID”, for example, identification information for identifying a brand included in the fund identified by the fund ID (an example of “brand identification information” for identifying a brand included in the financial instrument held by the user) is recorded.

The information included in the fund constituent brand DB 210B illustrated in FIG. 7 is an example, and the fund constituent brand DB 210B need not include at least a part of the items described above, or may further include other items.

In the example described above, the user information DB 210A included in the financial instrument database group 210 enables identification of the fund associated with the user, based on the user ID, and further, the fund constituent brand DB 210B included in the financial instrument database group 210 enables identification of the brand included in the fund, based on the fund ID. However, the financial instrument database group 210 is not limited to the example described above, and can include one or a plurality of databases or the like in any form as long as the database(s) can store the financial instrument associated with the user, the brand included in the financial instrument, and the like in direct or indirect association with the user ID (user identification information for identifying the user). The administrators of these databases included in the financial instrument database group 210 are not specifically limited. For example, the databases included in the financial instrument database group 210 may be databases proactively managed by the medium server 110 for provision of services, and the matching server 200 may perform access after acquiring permission to access these databases from the medium server 110 or the like. For example, the databases included in the financial instrument database group 210 may be databases proactively managed by a management company for financial instruments or the like, and the matching server 200 may perform access after acquiring permission to access these databases from the management company or the like. For example, the financial instrument database group 210 may be a database group proactively managed by the matching server 200.

Note that the example described above describes “brand” as a brand related to an individual company or the like included in the financial instrument such as an investment trust. However, this is not restrictive, and “brand” may be, for example, a constituent brand of a fund of funds, or a mother fund, an established ETF, or the like when an established financial instrument of an investment trust is a financial instrument having a mother-baby relationship such as an ETF. In other words, when the first financial instrument includes at least one second financial instrument as a brand, “brand” may be the second financial instrument. In this case, the financial instrument database group 210 may store the user ID in association with identification information (first financial instrument ID) of the first financial instrument, and store the first financial instrument ID in association with identification information (second financial instrument ID) of the second financial instrument in at least one database. The “brand identification information acquisition unit” included in the matching server 200 may refer to a predetermined storage unit such as the financial instrument database group 210 to acquire the second financial instrument ID directly or indirectly associated with the user ID, based on the user ID or the first financial instrument ID associated with the user ID.

### (2-5) Functional Configuration of Content Server 300

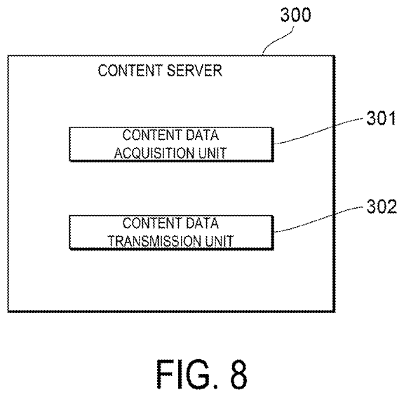

FIG. 8 is an exemplary block diagram illustrating a functional configuration of the content server 300. The content server 300 includes, for example, one or a plurality of computers 500, and acquires predetermined content data from the content data DB 310 in response to a content data request acquired from the matching server 200, and transmits the acquired predetermined content data to the matching server 200. The content server 300 may, for example, have a function as a demand-side platform (DSP). The content server 300 includes, for example, a content data acquisition unit 301 and a content data transmission unit 302.

The content data acquisition unit 301 acquires, for example, predetermined content data from the content data DB 310 in response to the content data request acquired from the matching server 200. Specifically, the content data acquisition unit 301 acquires content data associated with a content provider ID corresponding to the constituent brand ID (first brand ID) or the second brand ID included in the content data request from the content data DB 310. When customer attribute information is included in the content data request received from the matching server 200, the content data acquisition unit 301 may select a target setting appropriate for the customer attribute information among target settings included in the content data DB 310. When a content posting condition (any condition related to the advertisement, such as the position, the size, a posting period, and the like of the advertisement) is included in the content data request received from the matching server 200, the content data acquisition unit 301 may select a content publication condition appropriate for the content posting condition among content publication conditions included in the content data DB 310. The content data transmission unit 302 transmits, for example, the content data acquired by the content data acquisition unit 301 to the matching server 200. Note that, when the content data DB is configured as a part of a storage unit included in the content server 300, the content data acquisition unit 301 may refer to the storage unit included in the content server 300 to acquire the content data.

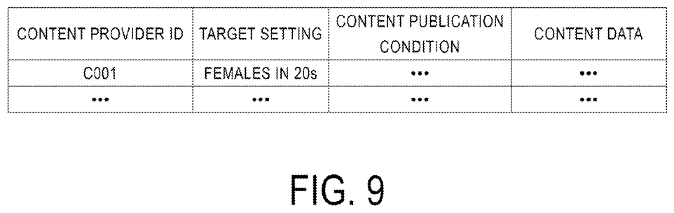

FIG. 9 is a diagram illustrating an exemplary data structure of the content data DB 310. In the content data DB 310, for example, “target setting”, “content publication condition”, and “content data” are recorded in association with “content provider ID”. In “content provider ID”, for example, an ID for identifying a provider of contents available for advertisement data (an example of “content provider identification information” for identifying a provider of contents) is recorded. The content provider supports brands included in any fund, and for example, may include brands of any financial instrument (stock funds, funds of funds, exchange traded funds (ETFs), fund wraps/discretionary investment contracts, robo-advisors, or the like) sold domestically and internationally. “Target setting” is, for example, a range of targets supposed to view an advertisement including content data, and can be defined by any piece of customer attribute information such as age-group, gender, residence, and an occupation. “Content publication condition” is a condition related to publication of contents, and can be freely set by a content provider or the like. “Content data” may be, for example, data related to any type of contents such as an image, a video, and a URL. The content data such as an image, a video, and a URL may be, for example, for use of advertising related to specific goods and services or the content provider itself. The URL may be, for example, a URL of a surveying website allowing conducting consumer surveys. Note that the content data DB 310 may be configured as a part of a storage unit included in the content server 300.

In the content data DB 310, for example, any content provider ID (first content provider ID) may be associated with any other content provider ID (second content provider ID). In this case, the content data acquisition unit 301 may identify the first content provider ID corresponding to the constituent brand ID (first brand ID) or the second brand ID included in the content data request and then acquire content data associated with the second content provider ID associated with the identified first content provider ID. Then, the content data transmission unit 302 may transmit the content data associated with the second content provider ID acquired by the content data acquisition unit 301 to the matching server 200. Association between the first content provider ID and the second content provider ID may be able to be registered and specified in the content data DB 310 by any user including the first content provider and the second content provider. The relationship of association between the first content provider and the second content provider may be in accordance with association between the first brand and the second brand, and for example, may be a capital relationship, a business relationship, or any other relationship. More specifically, for example, when the first content provider is a manufacturer, company A, of components (for example, parts of automobiles), it is assumed that manufacturers, company X and company Y, of final products (for example, automobiles) that are destinations of supply of the components are registered or specified as the second content provider associated with the first content provider, company A. In this case, when company A is included as the constituent brand ID or the like in the content data request transmitted from the matching server 200 to the content server 300, the content data of company X and company Y associated with company A is transmitted from the content server 300 to the matching server 200. Then, in the user terminal 20, advertisements of company X and company Y may be displayed. In this manner, company A can cooperate with and contribute to advertising and sales of the final products for company X and company Y being customers.

### (2-6) SNS Server 400

The SNS server 400 includes one or a plurality of computers, and provides a social networking service (SNS) for at least one user terminal 120. In other words, the SNS server 400 manages a graph (social graph) configured with mutual links of a plurality of users and a page (account page) associated with each user.

The account page is, for example, publicly released to a range of users set by the user via the SNS server 400, with a post of text, an image, and other contents by the user being added as needed. When there is “text of a document of the post (body of the post)” or a link as details of the post, the SNS server 400 manages a “uniform resource identifier (URI) (for example, a URL) of a reference file”, and manages at least “user name”, “hashtag”, or the like as metadata accompanying the post. Here, the hashtag is, for example, represented by a character string in which a hash mark “#” is added at the beginning in the post. By specifying the hashtag, the SNS server 400 can collectively search for and acquire posted data including the hashtag.

### (2) Operation

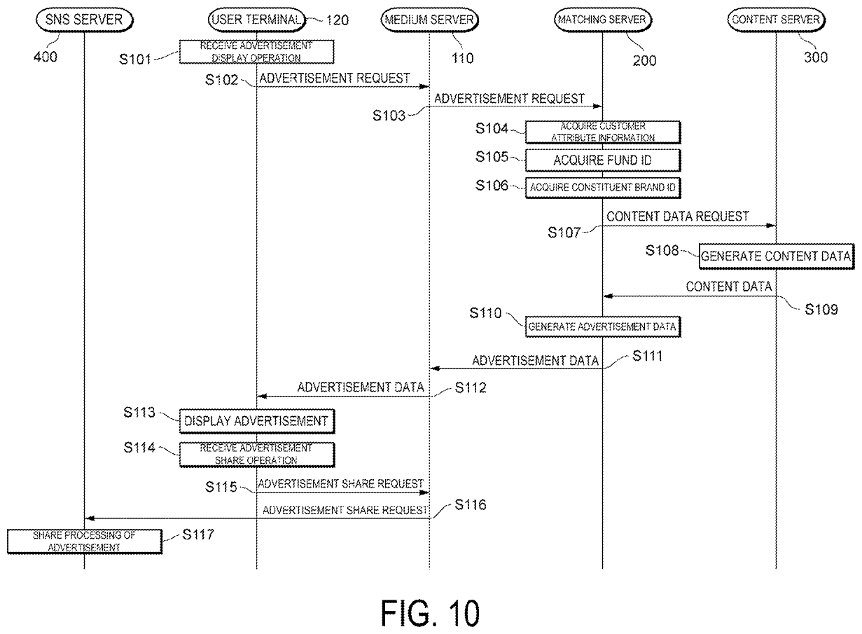

FIG. 10 is a diagram illustrating an exemplary operation sequence related to processing executed by the advertisement system 1 according to the present embodiment.

### (S101)

First, in a state in which any screen of a website, a service website, an application, or the like related to the financial service provided by the medium server 110 is displayed in the display apparatus 513 of the user terminal 120, when the user performs predetermined operation (advertisement display operation) preset as a trigger of advertisement display via the input I/F unit 507, the operation reception unit 121 of the user terminal 120 receives the advertisement display operation. The advertisement display operation may be, for example, information indicating that a predetermined region or a selection part included in a display screen is selected.

### (S102)

Next, the advertisement request transmission unit 122 of the user terminal 120 transmits an advertisement request to the medium server 110. The advertisement request may include information related to a display region of the advertisement (information related to the position, the size, and the like).

### (S103)

Next, when the advertisement request transmission unit 111 of the medium server 110 receives the advertisement request from the user terminal 120, the advertisement request transmission unit 111 transmits the advertisement request including the user ID associated with the user terminal 120 and the media company ID associated with the medium server 110 to the matching server 200. The medium server 110 may include a content posting condition in the advertisement request. Note that the advertisement request transmission unit 111 of the medium server 110 may transmit the fund ID associated with the user ID to the matching server 200.

### (S104)

The customer attribute information acquisition unit 202 of the matching server 200 acquires, from the user information DB 210A, customer attribute information of the user associated with the user ID included in the advertisement request transmitted from the medium server 110. The customer attribute information is, in a case of the user information DB 210A illustrated in FIG. 6, for example, gender, age-group, residence, and a work address; however, the matching server 200 may acquire any item depending on a configuration of the user information DB 210A as the customer attribute information.

### (S105)

Next, the fund ID acquisition unit 203 of the matching server 200 acquires, from the user information DB 210A, the fund ID associated with the user ID and the media company ID included in the advertisement request transmitted from the medium server 110. When there are a plurality of fund IDs associated with the user ID and the media company ID, the fund ID to be acquired may be determined based on a predetermined condition. For example, the fund ID to be acquired may be determined based on a fund balance, and in particular, a fund ID having the highest fund balance may be determined to be the fund ID to be acquired. Note that Step S105 of acquiring the fund ID need not be executed when the fund ID is linked to (the fund ID is transmitted to) the matching server 200 from the medium server 110.

### (S106)

Next, the constituent brand ID acquisition unit 204 of the matching server 200 acquires, from the fund constituent brand DB 210B, the constituent brand ID associated with the fund ID acquired in Step S105 (or provided from the medium server 110). When there are a plurality of constituent brand IDs, the constituent brand ID to be acquired may be determined based on a predetermined condition. For example, it may be based on the proportion of constituent brands, and the constituent brand ID of the highest proportion among the constituent brand IDs having the same fund ID may be determined to be the one constituent brand ID described above. Note that the matching server 200 may further refer to a predetermined storage unit regarding the acquired constituent brand ID as the first brand ID to acquire the second brand ID associated with the first brand ID. The processing of acquiring the second brand ID may be executed in any condition; however, for example, the condition may be acquisition of a notification of unavailability or the like of content data associated with the constituent brand ID (first brand ID) included in the content data request in Step S107, which will be described later, or the like from the content server 300.

### (S107)

Next, the content data acquisition unit 205 of the matching server 200 transmits, to the content server 300, a content data request including the constituent brand ID (first brand ID) or the second brand ID acquired in Step S106. In this process, the content data acquisition unit 205 may include the customer attribute information acquired in Step S104 in the content data request. The content data acquisition unit 205 may include a content posting condition of the media company related to the medium server 110 in the content data request.

### (S108)

When the content data acquisition unit 301 of the content server 300 receives the content data request from the matching server 200, the content data acquisition unit 301 acquires, from the content data DB 310, content data (an image, a video, a URL, or the like) according to the content data request. Specifically, the content data acquisition unit 301 acquires content data associated with a content provider ID corresponding to the constituent brand ID (first brand ID) or the second brand ID included in the content data request from the content data DB 310. Note that the “content data” is not limited to contents related to goods and services provided by the content provider itself, and may include contents related to goods and services provided by an affiliated company or the like having a predetermined relationship (a relationship in accordance with the relationship between the first brand and the second brand described above, including a capital relationship, a business relationship, and any other relationship) with the content provider. When customer attribute information is included in the content data request received from the matching server 200, the content data acquisition unit 301 may select a target setting appropriate for the customer attribute information among target settings included in the content data DB 310. When a content posting condition (any condition related to the advertisement, such as the position, the size, a posting period, and the like of the advertisement) is included in the content data request received from the matching server 200, the content data acquisition unit 301 may select a content publication condition appropriate for the content posting condition among content publication conditions included in the content data DB 310. Note that, when the content data DB 310 is configured as a part of a storage unit included in the content server 300, the content data acquisition unit 301 may refer to the storage unit included in the content server 300 to acquire the content data.

### (S109)

The content data transmission unit 302 of the content server 300 transmits the acquired content data to the matching server 200.

### (S110)

The advertisement data generation unit 206 of the matching server 200 generates advertisement data, based on content data acquired from the content server 300. In this process, the advertisement data generation unit 206 may generate data of display (an example of “financial instrument display” which is display related to a financial instrument) related to the fund related to the fund ID acquired in Step S105, and include the generated data in the advertisement data. The details of the display are not specifically limited as long as the display displays the name of the fund (financial instrument) or the like, and may be, for example, text of “invested by xx” (where xx is a fund name) or the like. In this manner, for example, when the user terminal 120 displays the advertisement data in the display apparatus 513 or the like, display related to the fund is displayed together with the contents of the advertisement.

### (S111)

The advertisement data transmission unit 207 of the matching server 200 transmits the generated advertisement data to the medium server 110 that has transmitted the advertisement request in Step S103.

### (S112)

Next, the advertisement data transmission unit 113 of the medium server 110 transmits, to the user terminal 120, the advertisement data acquired from the matching server 200.

### (S113)

The output unit 124 of the user terminal 120 displays the advertisement in the display apparatus 513, based on the advertisement data received from the medium server 110.

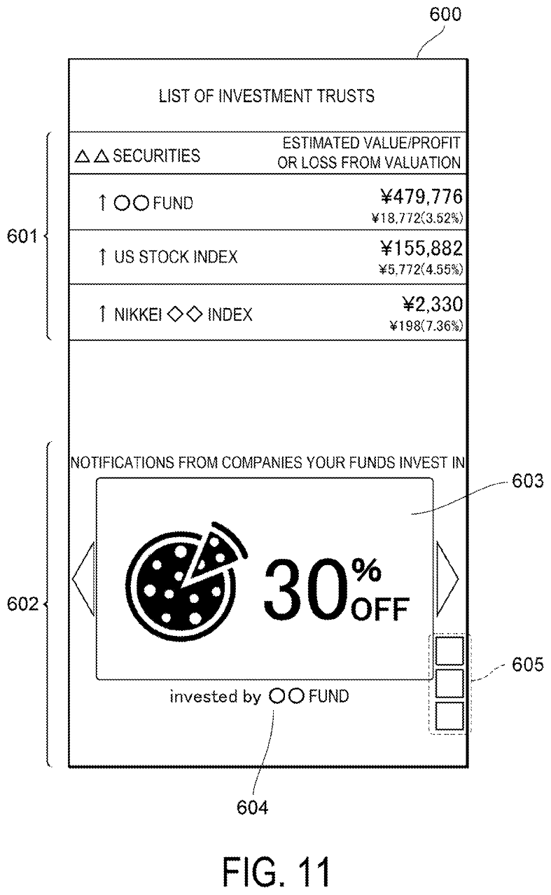

FIG. 11 is a diagram illustrating an exemplary display screen of an advertisement in a financial service. FIG. 11 illustrates, as an example, a screen 600 of a household account book application that manages investment trusts. The screen 600 includes a main region 601 and an advertisement region 602. In the main region 601, information related to a main function for management of the investment trusts or the like in the household account book application is displayed. For example, in the main region 601, the name of each investment trust held by the user and the estimated value/profit or loss from valuation of the investment trust are displayed.

In the advertisement region 602, an advertisement based on the advertisement data generated by the matching server 200, information associated with the advertisement, and the like are displayed. In the advertisement region 602, an advertisement displayed based on the advertisement data generated by the matching server 200 and the like are included. Specifically, in the advertisement region 602, an advertisement image 603 and text 604 of “invested by XX fund” are included. The advertisement image 603 may be an advertisement related to goods and services or the like provided by a brand company or the like corresponding to the constituent brand ID (first brand ID) described above, or may be an advertisement related to goods and services or the like provided by an affiliated company or the like corresponding to the second brand ID described above. In the example of FIG. 11, the advertisement image 603 is included as an advertisement in the advertisement region 602; however, a video, a URL, or the like, instead of an image, may be displayed. The text 604 is display indicating that an advertiser (content provider) of the advertisement image 603 is a brand of a specific fund (an example of “financial instrument display” which is display related to a financial instrument). The mode of the display (financial instrument display) is not specifically limited as long as the display is display related to a financial instrument, and not only the text but also an image, a video, or the like may be included. In the example of FIG. 11, a phrase “invested by” indicating that the advertiser receives investment by a predetermined fund is shown; however, this is not restrictive and any phrase or the like may be shown.

As illustrated in FIG. 11, in the screen 600, a share selection part 605 for selecting sharing with an SNS is included near a lower right part of the advertisement image 603. Each of rectangular objects of the share selection part 605 is a selection part for sharing the advertisement illustrated in advertisement region 602 with a specific SNS.

### (S114)

FIG. 10 is referred to again. In a state in which the screen 600 illustrated in FIG. 11 or the like is displayed in the display apparatus 513 of the user terminal 120, when the user performs operation (advertisement share operation) of selecting any object included in the share selection part 605 via the input I/F unit 507, the operation reception unit 121 of the user terminal 120 receives the advertisement share operation.

### (S115)

Next, the advertisement share request transmission unit 125 of the user terminal 120 transmits, to the medium server 110, an advertisement share request for requesting sharing of the advertisement with an SNS corresponding to the selected object. The advertisement share request includes, for example, the user ID and the identification information for identifying the advertisement data to be shared.

### (S116)

Next, the advertisement share request transmission unit 114 of the medium server 110 includes the advertisement data in the advertisement share request and transmits the advertisement data to the SNS server 400.

### (S117)

The SNS server 400 executes processing of sharing the advertisement, based on the advertisement share request received from the medium server 110. Specifically, the SNS server 400 adds, as a post, contents based on the advertisement data included in the advertisement share request to an account page associated with a user account identified by the user ID included in the advertisement share request. In this manner, the post is publicly released to predetermined users of the SNS provided by the SNS server 400.

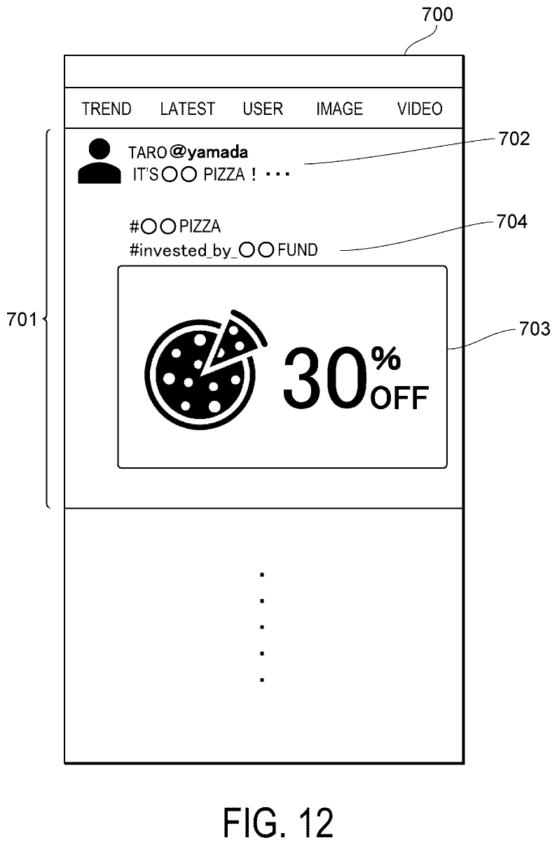

FIG. 12 is a diagram illustrating an example of a display screen of an advertisement shared in an SNS. FIG. 12 illustrates, as an example, a screen 700 of an account page in an SNS of a user who has shared an advertisement. In the screen 700, a post of the shared advertisement is displayed in a region 701. In a part denoted by the reference sign 702 in the region 701, a thumbnail image of the user related to the account page, a user name, posted text input by the user, and the like are included. In the region 701, an advertisement image 703 is included. In the region 701, a hashtag 704 is included. The hashtag 704 is metadata associated with the post. The hashtag 704 may be specified by the user themselves when the user performs the advertisement share operation in Step S114 described above. Alternatively, the hashtag 704 may be automatically added using a function of the SNS server 400.

### REFERENCE SIGNS LIST

1 Advertisement system
100 Financial service providing system
110 Medium server
111 Advertisement request transmission unit
112 Advertisement data acquisition unit
114 Advertisement share request transmission unit
120 User terminal
121 Operation reception unit
122 Advertisement request transmission unit
123 Advertisement data acquisition unit
124 Output unit
125 Advertisement share request transmission unit
200 Matching server
201 Advertisement request acquisition unit
202 Customer attribute information acquisition unit
203 Fund ID acquisition unit
204 Constituent brand ID acquisition unit
205 Content data acquisition unit
206 Advertisement data generation unit
207 Advertisement data transmission unit
300 Content server
301 Content data acquisition unit
302 Content data transmission unit
400 SNS server
500 Computer
501 Processor
503 Memory
505 Storage apparatus
507 Input I/F unit
509 Data I/F unit
511 Communication I/F unit
513 Display apparatus

1. An information processing apparatus comprising:
an advertisement request acquisition unit configured to acquire, from a financial service providing system for providing a service related to financing, user identification information for identifying a user of the service and a request for provision of an advertisement to be displayed in association with the service;
a brand identification information acquisition unit configured to refer to a predetermined storage unit to acquire brand identification information for identifying a brand associated with a financial instrument associated with the user, the brand identification information being associated with the user identification information;
a content data acquisition unit configured to acquire, from a content server configured to manage content data in association with content provider identification information for identifying a provider of contents, content data associated with the content provider identification information corresponding to the brand identification information that is identified;
an advertisement data generation unit configured to generate advertisement data including the acquired content data; and
an advertisement data transmission unit configured to transmit the generated advertisement data to the financial service providing system.

2. The information processing apparatus according to claim 1, wherein
the advertisement request acquisition unit further acquires service provider identification information for identifying a provider of the service, and
the brand identification information acquisition unit acquires the brand identification information associated with the user identification information and the service provider identification information.

3. The information processing apparatus according to claim 1 or 2, wherein
the predetermined storage unit stores the user identification information and financial instrument identification information for identifying a financial instrument associated with the user in association with each other.

4. The information processing apparatus according to any one of claims 1 to 3, wherein
the brand identification information acquisition unit acquires financial instrument identification information for identifying a financial instrument associated with the user identification information, and acquires the brand identification information associated with the financial instrument identification information.

5. The information processing apparatus according to any one of claims 1 to 4, wherein
the content data includes at least any one of an image, a video, or a URL of a webpage.

6. The information processing apparatus according to any one of claims 1 to 5, wherein
the advertisement data generation unit includes financial instrument display in the advertisement data, the financial instrument display being display related to the financial instrument.

7. The information processing apparatus according to any one of claims 1 to 6, wherein
the advertisement data generation unit includes, in the advertisement data, a selection part for sharing the advertisement data with a social networking service (SNS).

8. The information processing apparatus according to any one of claims 1 to 7, wherein
the brand associated with the financial instrument associated with the user includes at least any one of a first brand included in the financial instrument associated with the user or a second brand associated with the first brand.

9. An information processing method executed by a computer, the information processing method comprising:
acquiring, from a financial service providing system for providing a service related to financing, user identification information for identifying a user of the service and a request for provision of an advertisement to be displayed in association with the service;
referring to a predetermined storage unit to acquire brand identification information for identifying a brand associated with a financial instrument associated with the user, the brand identification information being associated with the user identification information;
acquiring, from a content server configured to manage content data in association with content provider identification information for identifying a provider of contents, content data associated with the content provider identification information corresponding to the brand identification information that is identified;
generating advertisement data including the acquired content data; and
transmitting the generated advertisement data to the financial service providing system.

10. A program for causing a computer to execute:
acquiring, from a financial service providing system for providing a service related to financing, user identification information for identifying a user of the service and a request for provision of an advertisement to be displayed in association with the service;
referring to a predetermined storage unit to acquire brand identification information for identifying a brand associated with a financial instrument associated with the user, the brand identification information being associated with the user identification information;
acquiring, from a content server configured to manage content data in association with content provider identification information for identifying a provider of contents, content data associated with the content provider identification information corresponding to the brand identification information that is identified;
generating advertisement data including the acquired content data; and
transmitting the generated advertisement data to the financial service providing system.
